(19) United States
(12) Patent Application Publication
(10) Pub. No.: US 2026/0186231 A1
(43) Pub. Date: Jul. 2, 2026

(54) OPTICAL APPARATUS

(71) Applicant: CANON KABUSHIKI KAISHA, Tokyo (JP)

(72) Inventors: JUNYA HIRANO, Tochigi (JP); KAZUHIRO NOGUCHI, Tochigi (JP)

(21) Appl. No.: 19/552,108

(22) Filed: Feb. 27, 2026

Related U.S. Application Data
(63) Continuation of application No. PCT/JP2024/026919, filed on Jul. 29, 2024.

(30) Foreign Application Priority Data
Oct. 4, 2023 (JP) 2023-172798

(51) Int. Cl. G02B 7/02; H02K 7/06

(52) U.S. Cl. CPC G02B 7/023; H02K 7/06

(57) ABSTRACT

An optical apparatus may include a holding member movable in an optical axis direction, a screw member extending in the optical axis direction and rotatable, a transmission member configured to engage with the screw member and transmit power in the optical axis direction according to rotation of the screw member, a coupling member configured to be coupled to the holding member and rotatably support the transmission member, a contact member configured to contact the transmission member, a first biasing unit configured to bias the contact member toward the transmission member in the optical axis direction, and a second biasing unit configured to bias the transmission member toward the screw member. In the optical axis direction, the transmission member may be biased toward the coupling member by the contact member. In the optical axis direction, the coupling member may be biased toward the holding member by the transmission member.

### CROSS-REFERENCE TO RELATED APPLICATIONS

This application is a Continuation of International Patent Application No. PCT/JP2024/026919, filed on Jul. 29, 2024, which claims the benefit of Japanese Patent Application No. 2023-172798, filed on Oct. 4, 2023, both of which are hereby incorporated by reference herein in their entirety.

### BACKGROUND

### Field of the Technology

The present disclosure relates to an optical apparatus.

### Description of the Related Art

In a leadscrew-rack power transmission mechanism that converts the rotational force of a leadscrew into linear force in the rotation axis direction, generates sliding friction load between the leadscrew and the rack, and reduces drive efficiency. PCT International Publication No. 2023/048093 discloses a structure in which a moving body connected to a lens holding frame supports an annular member using a rotationally rolling element such as a bearing, the annular member is engaged with the leadscrew, and the leadscrew and annular member roll and become a rolling resistance load, thereby reducing the load on the power source. Japanese Utility-Model Application Publication No. 61-040770 discloses a structure in which a roller is pivotally supported on an optical head, the roller is engaged with the leadscrew, and the leadscrew and roller roll and become a rolling resistance load, thereby reducing the load on the power source.

### SUMMARY

An optical apparatus according to one aspect of the present disclosure may include a holding member movable in an optical axis direction, a screw member extending in the optical axis direction and rotatable, a transmission member configured to engage with the screw member and transmit power in the optical axis direction according to rotation of the screw member, a coupling member configured to be coupled to the holding member and rotatably support the transmission member, a contact member configured to contact the transmission member, a first biasing unit configured to bias the contact member toward the transmission member in the optical axis direction, and a second biasing unit configured to bias the transmission member toward the screw member. In the optical axis direction, the transmission member may be biased toward the coupling member by the contact member. In the optical axis direction, the coupling member may be biased toward the holding member by the transmission member.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B are explanatory diagrams of an optical apparatus according to a first embodiment.

FIGS. 2A and 2B are perspective views of a power transmission member according to the first embodiment.

FIGS. 3A, 3B, 3C, and 3D are exploded perspective views and perspective views of the power transmission member according to the first embodiment.

FIGS. 4A, 4B, 4C, and 4D are explanatory diagrams of the power transmission member according to the first embodiment.

FIGS. 5A, 5B, 5C, and 5D are explanatory diagrams of loss reduction according to the first embodiment.

FIGS. 6A and 6B are explanatory diagrams illustrating an optical apparatus according to a second embodiment.

FIG. 7 is a cross-sectional view of a power transmission member according to the second embodiment.

FIGS. 8A and 8B are explanatory diagrams of an optical apparatus according to a third embodiment.

FIGS. 9A and 9B are explanatory diagrams of a power transmission member according to the third embodiment.

FIGS. 10A, 10B, 10C, and 10D are exploded perspective views and perspective views of a structure of the power transmission member according to the third embodiment.

FIGS. 11A and 11B are explanatory diagrams of the power transmission member according to the third embodiment.

FIGS. 12A, 12B, 12C, 12D, and 12E are explanatory diagrams of a biased state according to the third embodiment.

### DESCRIPTION OF THE EMBODIMENTS

Referring now to the accompanying drawings, a detailed description will be given of embodiments according to the present disclosure. Corresponding elements in respective figures will be designated by the same reference numerals, and a duplicate description thereof will be omitted.

The structure disclosed in PCT International Publication No. 2023/048093 uses the rotationally rolling element such as bearings, which tend to generate rolling noise from the rolling balls and increase drive noise. Furthermore, incorporating the rotationally rolling element such as bearings increases the size of the apparatus. Moreover, the structure disclosed in Japanese Utility-Model Application Publication No. 61-040770 does not specifically describe the specific roller support structure.

### First Embodiment

### (1-1) Overall Structure

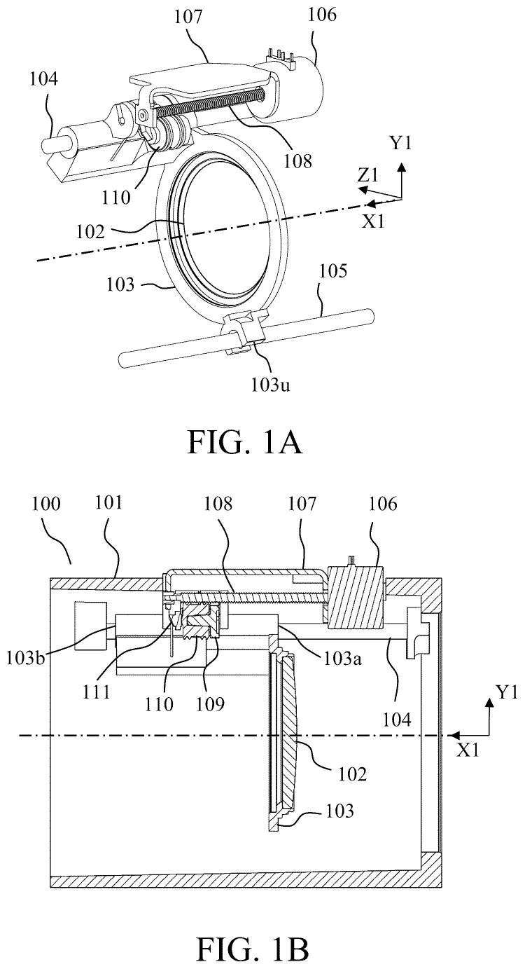

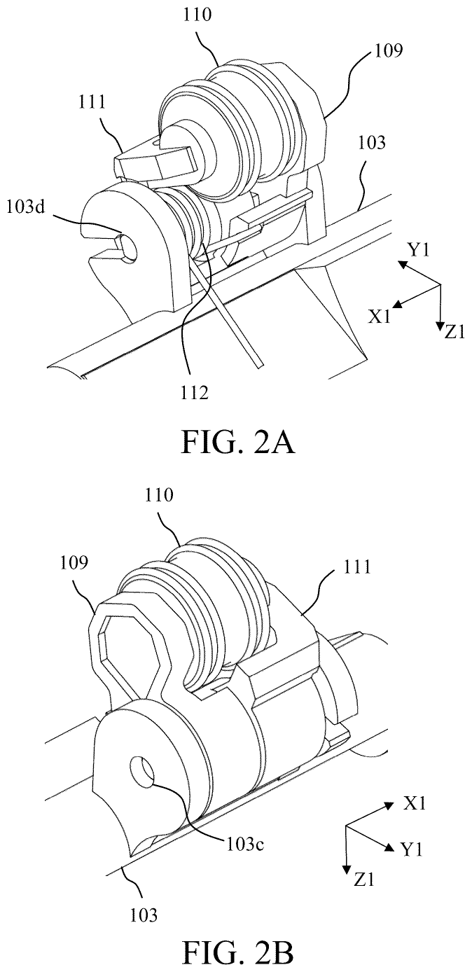

FIG. 1A is a perspective view illustrating a structure of an optical apparatus 100 from which a fixed barrel 101 is removed, and FIG. 1B is a cross-sectional view of the optical apparatus 100. FIGS. 2A and 2B are perspective views illustrating an enlarged power transmission member (transmission member) 110 from which a leadscrew (screw member) 108 is removed, viewed from different directions. In the present embodiment, a direction parallel to an optical axis of a lens 102 (an optical axis direction) will be defined as an X1 direction, a direction orthogonal to the X1 direction and corresponding to an up-down direction of the optical apparatus 100 will be defined as a Y1 direction, and a direction orthogonal to both the X1 direction and the Y1 direction will be defined as a Z1 direction, as indicated by arrows in the drawings.

The optical apparatus 100 includes a lens holding frame (holding member) 103 that holds the lens 102, and a main guide bar 104 and a sub guide bar 105 each having a cylindrical shaft shape, whose axial directions are parallel to the X1 direction and which linearly guide the lens holding frame 103 in the optical axis direction of the lens 102. The optical apparatus 100 further includes a sheet metal portion 107, a power source (actuator) 106 fixed to the sheet metal portion 107, and a leadscrew 108 whose rotation axis direction is parallel to the X1 direction (extends in the X1 direction) and which is coupled to the power source 106. When electric power is supplied to the power source 106 from a power supply or the like (not illustrated), the leadscrew 108 is rotationally driven (rotated). In the present embodiment, a stepping motor is used as the power source 106; however, a different power source may be used as long as it can rotationally drive the leadscrew 108. The optical apparatus 100 further includes a coupling member 109 configured to be coupled to (or that is coupled to) the lens holding frame 103, a power transmission member 110 that is rotatably and slidably supported by the coupling member 109, a contact member 111 that contacts the power transmission member 110, and a compression torsion spring 112.

Both ends of the main guide bar 104 and the sub guide bar 105 are fixed to fixing portions (not illustrated) of the fixed barrel 101. The sheet metal portion 107 and the power source 106 fixed to the sheet metal portion 107 are fixed to the fixed barrel 101.

The lens holding frame 103 includes guide hole portions 103a and 103b that are engaged with the main guide bar 104, and a guide groove portion 103u that contacts the sub guide bar 105. The lens holding frame 103 is supported movably in the X1 direction by the guide hole portions 103a and 103b and the main guide bar 104, and rotation about an axis of the main guide bar 104 is restricted by the guide groove portion 103u and the sub guide bar 105. In the present embodiment, the main guide bar 104 and the sub guide bar 105 are used as a guide unit for the lens holding frame 103; however, a different structure may be used as long as the lens holding frame 103 can be supported movably in the X1 direction. The lens holding frame 103 further includes coupling hole portions 103c and 103d that are parallel to the X1 direction and to which the coupling member 109 is coupled. The coupling member 109 is coupled rotatably about axes of the coupling hole portions 103c and 103d.

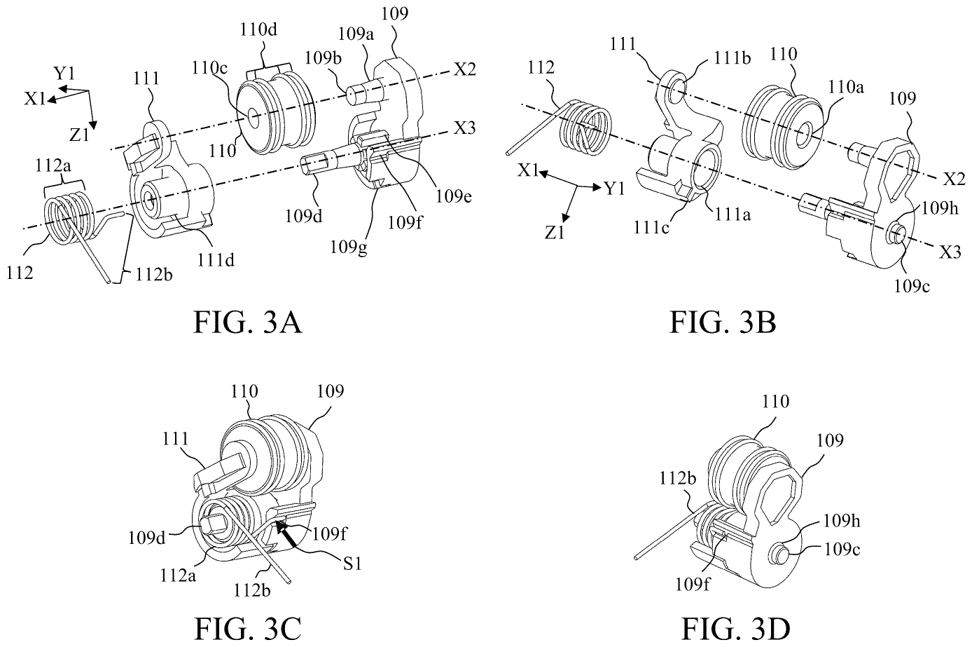

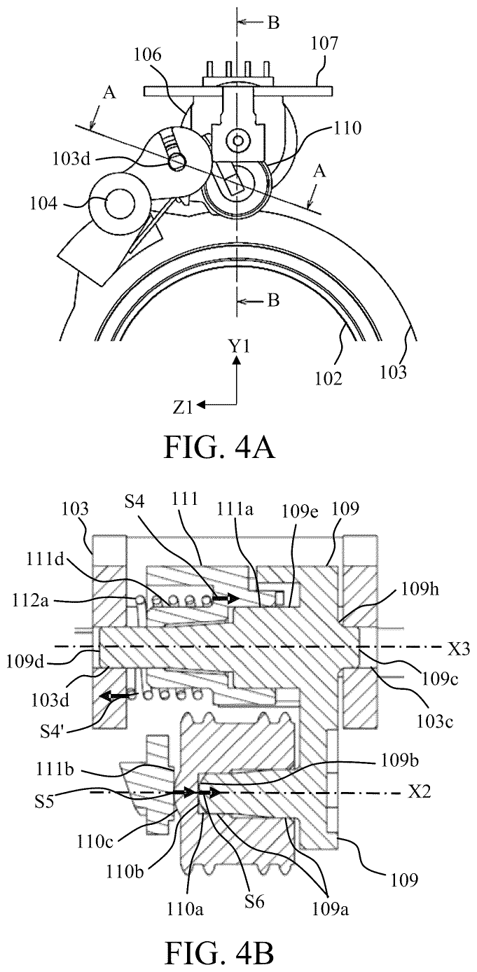

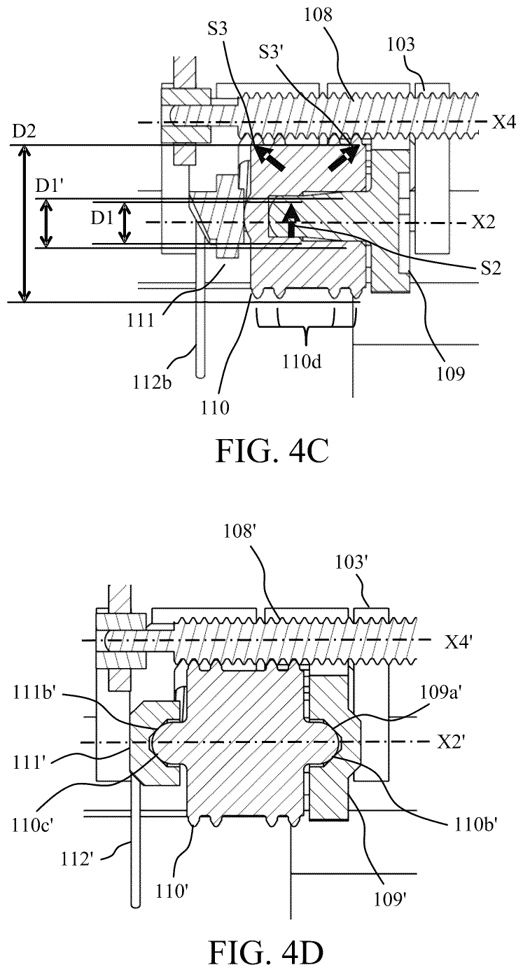

FIGS. 3A and 3B are exploded perspective views of components around the power transmission member 110, viewed from different directions. FIGS. 3C and 3D are perspective views of assembled states of FIGS. 3A and 3B, respectively. FIG. 4A is an enlarged view of a part around the power source 106 of the optical apparatus 100 from which the fixed barrel 101 is removed, viewed from a direction opposite to the X1 direction. FIGS. 4B and 4C are cross-sectional views taken along lines A-A and B-B of FIG. 4A, respectively. FIG. 4D is a sectional view taken along line B-B illustrating a case where the power transmission member 110 has a different support structure.

The coupling member 109 includes a sliding support shaft portion 109a and a sliding support surface portion 109b that rotatably and slidably support the power transmission member 110 about an X2 axis parallel to the X1 direction. The sliding support shaft portion 109a and the sliding support surface portion 109b function as a support portion that rotatably and slidably supports the power transmission member 110. The coupling member 109 further includes coupling shaft portions 109c and 109d that are rotatably coupled to the coupling hole portions 103c and 103d about an X3 axis parallel to the X1 direction. The coupling member 109 further includes an engagement shaft portion 109e that is engaged with the contact member 111, a rotation restriction portion 109g that restricts relative rotation relative to the contact member 111, and an offset portion 109f to which a biasing force of a torsion spring portion 112b of the compression torsion spring 112 is transmitted. The coupling member 109 further includes a conical portion 109h that contacts the lens holding frame 103 in the X1 direction.

The power transmission member 110 includes a sliding hole portion 110a and a sliding surface portion 110b that is rotatably and slidably supported by the coupling member 109, and a sliding surface portion 110c that rotatably and slidably contacts the contact member 111. The power transmission member 110 further includes a circumferential tooth portion (engagement portion) 110d that is engaged with a thread portion of the leadscrew 108.

The contact member 111 includes an engagement hole portion 111a that is engaged with the coupling member 109 on the X3 axis, and a rotation restriction portion 111c that restricts relative rotation relative to the coupling member 109 about the X3 axis. The contact member 111 further includes a slidable contact surface portion 111b that rotatably and slidably contacts the power transmission member 110, and a spring shaft portion 111d in which a compression spring portion 112a of the compression torsion spring 112 is incorporated.

The compression torsion spring 112 includes a compression spring portion (first biasing means) 112a and a torsion spring portion (second biasing means) 112b. The compression spring portion 112a biases the contact member 111 from the lens holding frame 103 toward the power transmission member 110 in the X1 direction. The torsion spring portion 112b biases both the lens holding frame 103 and the coupling member 109 in a direction orthogonal to the X1 direction, which is an optical-axis orthogonal direction, and biases the power transmission member 110 toward the leadscrew 108.

A biasing state of each component in a direction orthogonal to the X1 direction will be described below. The coupling hole portions 103c and 103d are rotatably coupled to the coupling shaft portions 109c and 109d about the X3 axis, and are biased at the offset portion 109f by the torsion spring portion 112b with a biasing force S1 illustrated in FIG. 3C. Due to the biasing force S1, the sliding support shaft portion 109a is biased against a side surface of the sliding hole portion 110a of the power transmission member 110 with a biasing force S2 illustrated in FIG. 4C. Further, due to the biasing force S2, the circumferential tooth portion 110d is biased against the thread portion of the leadscrew 108 with biasing forces S3 and S3′ illustrated in FIG. 4C. At this time, rotation of the coupling member 109 about the X3 axis causes the circumferential tooth portion 110d to be engaged with the leadscrew 108. As described above, by biasing the coupling member 109 with the torsion spring portion 112b, the thread portion of the leadscrew 108 and the circumferential tooth portion 110d can be engaged with each other without backlash.

The torsion spring portion 112b also biases the lens holding frame 103 toward the main guide bar 104 and the sub guide bar 105. Thus, backlash in a direction orthogonal to the X1 direction between the guide hole portions 103a and 103b and the main guide bar 104, and backlash in a direction orthogonal to the X1 direction between the guide groove portion 103u and the sub guide bar 105 can be suppressed.

A biasing state of each component in the X1 direction will be described below. The contact member 111 is engaged with the engagement shaft portion 109e through the engagement hole portion ll1a, and rotation about the X3 axis is restricted by the rotation restriction portions 109g and 111c; therefore, the contact member 111 is configured to be movable only in a direction parallel to the X3 axis.

The spring shaft portion 111d is biased by the compression spring portion 112a with a biasing force S4 illustrated in FIG. 4B. Due to the biasing force S4, the contact member 111 moves in a direction parallel to the X3 axis, and the slidable contact surface portion 1l1b is biased against the sliding surface portion 110c. Since the other end of the compression spring portion 112a contacts the lens holding frame 103, the lens holding frame 103 receives, in the X1 direction, a biasing force S4′ opposite to the biasing force S4. Further, due to a biasing force S5 applied to the sliding surface portion 110c, the sliding surface portion 110b is biased against the sliding support surface portion 109b. Furthermore, due to a biasing force S6 applied to the sliding support surface portion 109b, the conical portion 109h is biased against the coupling hole portion 103c. As described above, the compression spring portion 112a biases the coupling member 109, the power transmission member 110, and the contact member 111 toward the lens holding frame 103 in the X1 direction without backlash.

Next, a power transmission member 110′ having a support structure different from that of the power transmission member 110 illustrated in FIG. 4D will be described. The power transmission member 110′ includes sliding shaft portions 110b′ and 110c′. The sliding shaft portions 110b′ and 110c′ contact a conical bearing 109a′ provided on a coupling member 109′ and a conical bearing 111b′ of a contact member 111′, respectively. The conical bearing 109a′ functions as a support portion that rotatably and slidably supports the power transmission member 110. In the structure of FIG. 4D as well, biasing states in the X1 direction and in a direction orthogonal to the X1 direction are the same as those in FIGS. 3A to 4C, and thus a description thereof will be omitted.

The support structure of the power transmission member may be the structure illustrated in FIG. 4C or the structure illustrated in FIG. 4D, as long as the power transmission member can be rotatably supported by a contact surface that includes a rotation axis of the power transmission member. The contact surface may be provided near a center of the rotation axis of the power transmission member since an effect of load reduction described later is increased.

Next, an engagement structure between the power transmission member 110 and the leadscrew 108 will be described. The power transmission member 110 includes the circumferential tooth portion 110d on an outer diameter side. The circumferential tooth portion 110d is biased so as to be engaged with the thread portion of the leadscrew 108 that is rotationally driven by the power source 106. The circumferential tooth portion 110d is configured to be continuous over an entire circumference on the outer diameter side of the power transmission member 110, and is biased so as to be always engaged with the leadscrew 108 even when the power transmission member 110 slides and rotates relative to the coupling member 109. However, the engagement structure between the leadscrew 108 and the power transmission member 110 may have a different shape as long as the leadscrew 108 and the power transmission member 110 can be engaged with each other. As described above, the power transmission member 110 is biased rotatably about the X2 axis by the sliding hole portion 110a relative to the sliding support shaft portion 109a, and is biased rotatably while being sandwiched between the sliding support surface portion 109b and the slidable contact surface portion 111b.

Due to the above structure, when the leadscrew 108 is rotationally driven by the power source 106, the thread portion of the leadscrew 108 apparently moves in a rotation axis direction of the leadscrew 108. The circumferential tooth portion 110d that is engaged with the thread portion rolls and rotates while being engaged with the leadscrew 108, and the lens 102, the lens holding frame 103, the coupling member 109, the power transmission member 110, the contact member 111, and the compression torsion spring 112 move in the X1 direction. The structure of the present embodiment satisfies the following inequality (1):

$$T 1 > T 2 \qquad ( 1 )$$

Here, T1 is a rotational resistance torque acting on the circumferential tooth portion 110d in a case where the power transmission member 110 is engaged with and slides against the leadscrew 108. T2 is a rotational resistance torque acting on the sliding support shaft portion 109a in a case where the coupling member 109 and the power transmission member 110 rotate relative to each other about the X2 axis. By satisfying inequality (1), the power transmission member 110 does not slide while being engaged with the leadscrew 108, but rolls and rotates while being engaged with the leadscrew 108, and rotates relative to the coupling member 109. For example, a case will be described where a friction coefficient 1 between the power transmission member 110 and the leadscrew 108 and a friction coefficient 2 between the power transmission member 110 and the coupling member 109 are the same, a diameter of the sliding hole portion 110a is D1, and a diameter of the circumferential tooth portion 110d is D2. In this case, the rotational resistance torque T1 is proportional to the diameter D2 and a sum of the biasing forces S3 and S3′ illustrated in FIG. 4C, and the rotational resistance torque T2 is proportional to the diameter D1 and the biasing force S2. Since the diameter D2 is larger than the diameter D1, and although details will be described later, the sum of the biasing forces (normal forces) S3 and S3′ is larger than the biasing force S2, the rotational resistance torque T1 becomes larger than the rotational resistance torque T2, and the power transmission member 110 rotates relative to the coupling member 109.

(1-2) about Loss Reduction

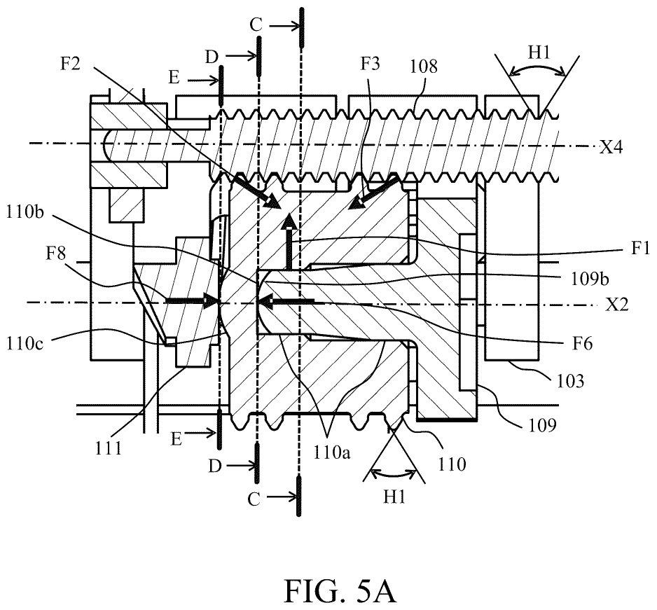

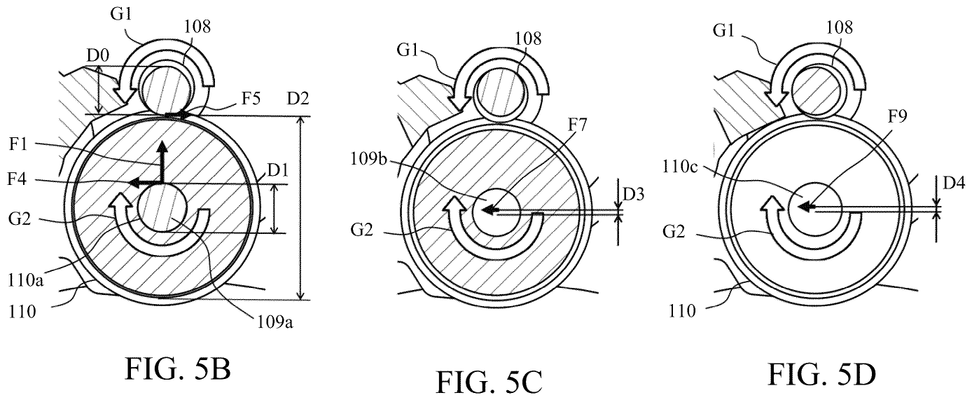

First, forces acting on the power transmission member 110 according to the present embodiment will be described. FIG. 5A illustrates forces F1 and F6 applied to the power transmission member 110 from the coupling member 109, forces F2 and F3 applied from the leadscrew 108, and a force F8 applied from the contact member 111. These forces are generated by the biasing forces S1 and S4 of the compression torsion spring 112. FIG. 5B is a cross-sectional view taken along line C-C in FIG. 5A. FIG. 5B illustrates a resistive force F4 generated when the leadscrew 108 rotates in direction G1 and the power transmission member 110 rotates in direction G2 while receiving the force F1, and a tangential force F5 for the leadscrew 108 to rotationally drive the power transmission member 110. FIG. 5C is a cross-sectional view taken along line D-D in FIG. 5A, and illustrates a resistive force F7 generated when the leadscrew 108 rotates in direction G1 and the power transmission member 110 rotates in direction G2 while receiving the force F6. FIG. 5D is a cross-sectional view taken along line E-E in FIG. 5A, and illustrates a resistive force F9 generated when the leadscrew 108 rotates in direction G1 and the power transmission member 110 rotates in direction G2 while receiving the force F8.

Next, loss reduction will be described. Here, DO is a diameter of the leadscrew 108. D1 is a diameter of the sliding hole portion 110a. D2 is a diameter of the circumferential tooth portion 110d that is engaged with the leadscrew 108. D3 is a diameter of a region where the coupling member 109 and the sliding surface portion 110b contact each other. D4 is a diameter of a region where the contact member 111 and the sliding surface portion 110c contact each other. Although, as illustrated in FIG. 4C, the sliding hole portion 110a has a two-step diameter of D1 and D1′, the diameters D1 and D1′ are substantially the same. Therefore, for simplicity, only the diameter D1 will be used in the following description. The force F1 is a force applied to the power transmission member 110 by the coupling member 109 as the torsion spring portion 112b biases the offset portion 109f. The forces F2 and F3 are forces applied to the power transmission member 110 by the leadscrew 108 as the power transmission member 110 is biased against the leadscrew 108 by the force F1. Further, since the leadscrew 108 and the circumferential tooth portion 110d are engaged with each other at a thread lead angle H1, the forces F2 and F3 act in directions perpendicular to the engaging surfaces. In the present embodiment, the thread lead angle H1 of the leadscrew 108 is 60°, and based on force equilibrium, the forces F2 and F3 have the same magnitude as that of the force F1.

With reference to FIG. 5B, a rotational resistance torque about the X2 axis of the power transmission member 110 generated by the force F1 will be described. When the leadscrew 108 is rotationally driven in direction G1, the structure of the present embodiment satisfies inequality (1), and thus the power transmission member 110 rolls and rotates while being engaging with the leadscrew 108. At this time, when the power transmission member 110 rotates in direction G2 while receiving the force F1, the resistive force F4 is generated between the coupling member 109 and the power transmission member 110. A rotational resistance torque T4 about the X2 axis of the power transmission member 110 due to the resistive force F4 is expressed by the following equation (2):

$$T 4 = F 4 \times ( D 1 / 2 ) \qquad ( 2 )$$

Further, the tangential force F5 for the leadscrew 108 to rotationally drive the power transmission member 110 while the rotational resistance torque T4 is generated satisfies the following inequality (3):

$$F 5 > F 4 / ( D 2 / D 1 ) \qquad ( 3 )$$

Thus, a rotational driving torque T5 for the leadscrew 108 to rotationally drive the power transmission member 110 is expressed by the following equation (4):

$$T 5 = F 5 \times D 0 / 2 \qquad ( 4 )$$

From inequality (3) and equation (4), the rotational driving torque T5 satisfies the following inequality (5) using the resistive force F4:

$$T 5 > ( F 4 / ( D 2 / D 1 ) ) \times ( D 0 / 2 ) \qquad ( 5 )$$

As illustrated in inequality (5), the rotational driving torque T5 for the leadscrew 108 to rotationally drive the power transmission member 110 is reduced by a ratio of the diameter D2 to the diameter D1. This means that the resistive force F4 generated at the diameter D1 between the coupling member 109 and the power transmission member 110 is reduced by the ratio of the diameter D2 to the diameter D1 at the position of the circumferential tooth portion 110d. Therefore, the tangential force F5 for the leadscrew 108 to rotationally drive the power transmission member 110 is reduced by the ratio of the diameter D2 to the diameter D1. However, increasing the diameter D2 increases the ratio of the diameter D2 to the diameter D1 and reduces the tangential force F5, but also increases the moment of inertia of the power transmission member 110 and increases the size of the optical apparatus 100. Therefore, a proper ratio of the diameter D2 to the diameter D1 may be set. From the viewpoint of preventing excessive increase in the size of the optical apparatus 100 and the moment of inertia of the power transmission member 110, the ratio of the diameter D2 to the diameter D1 may satisfy the following inequality (6):

$$1 < D 2 / D 1 < 100 \qquad ( 6 )$$

With reference to FIGS. 5A and 5C, a rotational resistance torque about the X2 axis of the power transmission member 110 generated by the force F6 will be described. The force F6 is a force applied to the power transmission member 110 from the coupling member 109, and corresponds to a force with which the compression spring portion 112a biases the contact member 111. When the power transmission member 110 rotates in direction G2 while receiving the force F6, the resistive force F7 is generated between the coupling member 109 and the power transmission member 110. At this time, a rotational resistance torque T7 about the X2 axis due to the resistive force F7 is expressed by the following equation (7):

$$T 7 = F 7 \times ( D 3 / 2 ) \qquad ( 7 )$$

By forming the sliding support surface portion 109b as a spherical surface or the like, the diameter D3 becomes approximately zero, and thus the rotational resistance torque T7 becomes a very small value, approximately zero. As described above, the resistive force F4 generated by the force F1 at the diameter D1 is reduced by the ratio of the diameter D2 to the diameter D1 at the position of the circumferential tooth portion 110d. Similarly, the resistive force F7 generated at the diameter D3 between the coupling member 109 and the power transmission member 110 is reduced by the ratio of the diameter D2 to the diameter D3 at the position of the circumferential tooth portion 110d. Therefore, the rotational resistance torque T7 has almost no effect on the tangential force F5 for the leadscrew 108 to rotationally drive the power transmission member 110, and can be ignored.

With reference to FIGS. 5A and 5D, a rotational resistance torque about the X2 axis of the power transmission member 110 generated by the force F8 will be described. The force F8 is a force applied to the power transmission member 110 from the contact member 111, and has the same magnitude as that of the force with which the compression spring portion 112a biases the contact member 111. When the power transmission member 110 rotates in direction G2 while receiving the force F8, the resistive force F9 is generated between the power transmission member 110 and the contact member 111. A rotational resistance torque T9 about the X2 axis due to the resistive force F9 is expressed by the following equation (8):

$$T 9 = F 9 \times ( D 4 / 2 ) \qquad ( 8 )$$

By forming the sliding surface portion 110c as a spherical surface or the like, the diameter D4 becomes approximately zero, and thus the rotational resistance torque T9 becomes a very small value, approximately zero. As described above, the resistive force F4 generated by the force F1 at the diameter D1 is reduced by the ratio of the diameter D2 to the diameter D1 at the position of the circumferential tooth portion 110d. Similarly, the resistive force F9 generated at the diameter D4 between the power transmission member 110 and the contact member 111 is reduced by the ratio of the diameter D2 to the diameter D4 at the position of the circumferential tooth portion 110d. Therefore, the rotational resistance torque T9 can be ignored because it has almost no effect.

Next, a rotational resistance torque in a hypothetical structure in which the power transmission member 110 does not rotate will be described. If the power transmission member 110 is fixed to the coupling member 109 and the leadscrew 108 is rotationally driven, the thread portion of the leadscrew 108 is engaged with the power transmission member 110, and resistive forces such as friction are generated against the forces F2 and F3 illustrated in FIG. 5A. The generated resistive force becomes a tangential force for the leadscrew 108 to rotate. For example, when a friction coefficient between the leadscrew 108 and the power transmission member 110 is μ, a frictional force of (F2+F3)×μ is generated. When the thread lead angle H1 is 60°, as described above, the forces F1, F2, and F3 are equal, and thus the frictional force becomes 2×F1×μ. In this case, a torque for the leadscrew 108 to rotate becomes greater than F1×μ×D0.

In the present embodiment, since the leadscrew 108 and the power transmission member 110 roll and rotate relative to each other, no resistive forces such as friction are generated by the forces F2 and F3, and instead a resistive force F4 due to the force F1 is generated. When a friction coefficient between the coupling member 109 and the power transmission member 110 is, the resistive force F4 becomes F1×μ. In this case, based on inequality (5), the rotational driving torque T5 for the leadscrew 108 to rotationally drive the power transmission member 110 becomes greater than {(F1×μ)/(D2/D1)}×(D0/2).

As described above, when the power transmission member 110 is configured to be rotatable, the leadscrew 108 can be rotated with a smaller load as compared with a case in which the power transmission member 110 is fixed, thereby driving the lens holding frame 103 in the X1 direction. Thereby, the resistive forces F4, F7, and F9 can be reduced by D2/D1, D2/D3, and D2/D4, respectively, thereby reducing losses occurring when force is transmitted from the leadscrew 108 to the power transmission member 110. Thus, an output such as a driving force of the lens holding frame 103 can be increased relative to a torque input transmitted from the power source 106 to the leadscrew 108, and an optical apparatus 100 with improved driving efficiency can be provided.

Next, effects obtained by rotatably and slidably supporting the power transmission member 110 by the coupling member 109 and the contact member 111 will be described. In the present embodiment, in a direction orthogonal to the X1 direction, the sliding hole portion 110a is rotatably and slidably supported by the coupling member 109, and in the X1 direction, the sliding surface portions 110b and 110c are rotatably and slidably supported while being sandwiched between the coupling member 109 and the contact member 111. Thus, all support portions of the power transmission member 110 are sliding bearings, and rolling elements such as bearings may not be used. Even when the power transmission member 110 rotates, vibration noise and driving noise can be reduced, and the size of the optical apparatus 100 can be reduced.

As described above, the structure of the present embodiment can provide a compact optical apparatus 100 having a reduced size, improved driving efficiency, and reduced vibration and driving noises by reducing load loss in power transmission.

### Second Embodiment

The present embodiment will discuss only structures different from those of the first embodiment, and will omit a description of common structures. In the present embodiment, components, shapes, and the like are assigned reference numerals in the 200 series. However, components and shapes that are the same as those of the first embodiment are assigned the same last two digits as in the first embodiment.

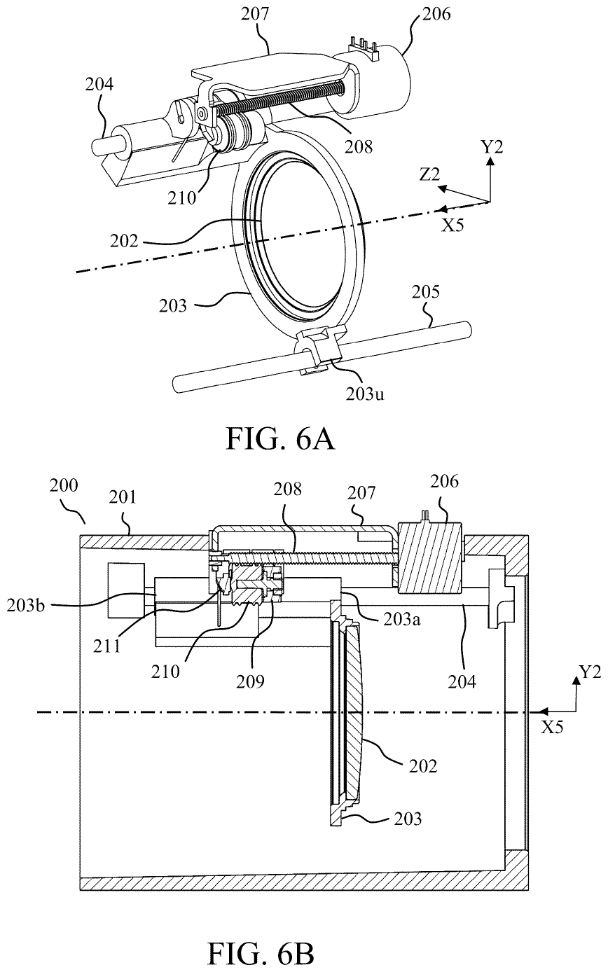

FIG. 6A is a perspective view of a structure of an optical apparatus 200 from which a fixed lens barrel 201 is removed, and FIG. 6B is a cross-sectional view of the optical apparatus 200. In the present embodiment, a direction parallel to the optical axis of a lens 202 (optical axis direction) will be defined as an X5 direction, a direction orthogonal to the X5 direction and corresponding to a vertical direction of the optical apparatus 200 will be defined as a Y2 direction, and a direction orthogonal to both the X5 direction and the Y2 direction will be defined as a Z2 direction, as indicated by arrows in the drawings.

The optical apparatus 200 includes a lens holding frame 203 that holds the lens 202, and a cylindrical main guide bar 204 and a cylindrical sub guide bar 205, each having an axial direction parallel to the X5 direction and configured to linearly guide the lens holding frame 203 in the optical axis direction of the lens 202. The optical apparatus 200 further includes a sheet metal portion 207, a power source 206 fixed to the sheet metal portion 207, and a leadscrew 208 having a rotation axis direction parallel to the X5 direction and coupled to the power source 206. When electric power is supplied to the power source 206 from an unillustrated power supply or the like, the leadscrew 208 is rotationally driven. The optical apparatus 200 further includes a coupling member 209 coupled to the lens holding frame 203, and a sliding shaft member 213 fixed to the coupling member 209 by a fixing nut 214. The optical apparatus 200 further includes a power transmission member 210 rotatably and slidably supported by the sliding shaft member 213, a contact member 211 that contacts the power transmission member 210, and a compression torsion spring 212.

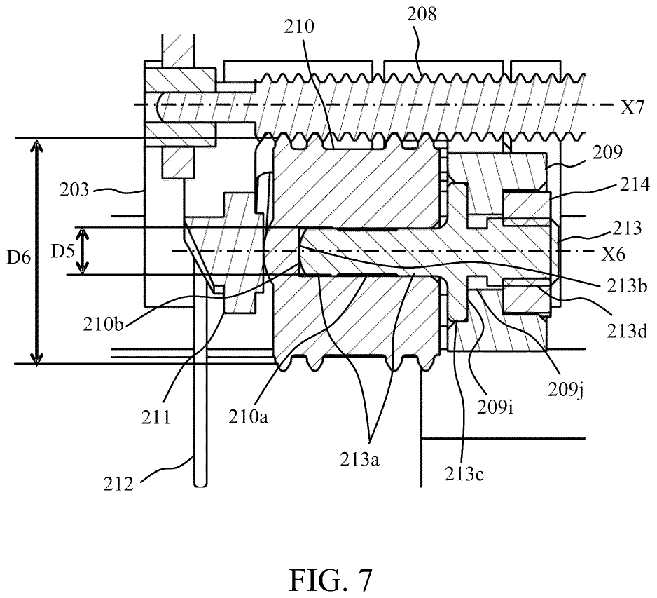

Next, with reference to FIG. 7, detailed shapes of the coupling member 209 and the sliding shaft member 213, and effects obtained by configuring the sliding shaft member 213 as a separate component from the coupling member 209 will be described. FIG. 7 is a cross-sectional view of the power transmission member 210.

The coupling member 209 includes an engagement hole portion 209i with which the sliding shaft member 213 is engaged, and a perforation hole portion 209j through which the sliding shaft member 213 passes. The sliding shaft member 213 includes a sliding support shaft portion 213a and a sliding support surface portion 213b that rotatably and slidably support the power transmission member 210 about an X6 axis parallel to the X5 direction. The sliding shaft member 213 further includes an engagement shaft portion 213c that is engaged with the coupling member 209, and a fixing screw portion 213d coupled to the fixing nut 214.

Hereinafter, the effects obtained by configuring the sliding shaft member 213 as a separate component from the coupling member 209 will be described. D5 is a diameter of a sliding hole portion 210a and the sliding support shaft portion 213a. D6 is a diameter of a circumferential tooth portion 210d that is engaged with the leadscrew 208. As described above, load reduction may be achieved based on a ratio of the diameter D6 to the diameter D5. By reducing the diameter D5, the ratio of the diameter D6 to the diameter D5 may be increased, thereby enhancing a load reduction effect. In the present embodiment, by forming the sliding shaft member 213 from a high-strength material such as metal, the diameter D5 of the sliding support shaft portion 213a may be reduced, thereby further enhancing the load reduction effect. In addition, forming the sliding shaft member 213 from a high-strength material such as metal may reduce wear caused by slidable rotation of the power transmission member 210 and may reduce a friction coefficient between the sliding shaft member 213 and the power transmission member 210. Further, as in the first embodiment, since no rolling elements such as bearings are used, vibration noise and driving noise may be reduced, and the size of the optical apparatus 200 may be reduced.

As described above, the structure according to the present embodiment can provide an optical apparatus 200 having a reduced size, improved driving efficiency, and reduced vibration and driving noises by reducing load loss in power transmission.

### Third Embodiment

### (3-1) Overall Structure

The present embodiment will discuss only structures different from those of the first and second embodiments, and will omit a description of structures common thereto. In the present embodiment, components, shapes, and the like are assigned reference numerals in the 300 series. However, components and shapes that are the same as those of the first embodiment are assigned the same last two digits as in the first embodiment.

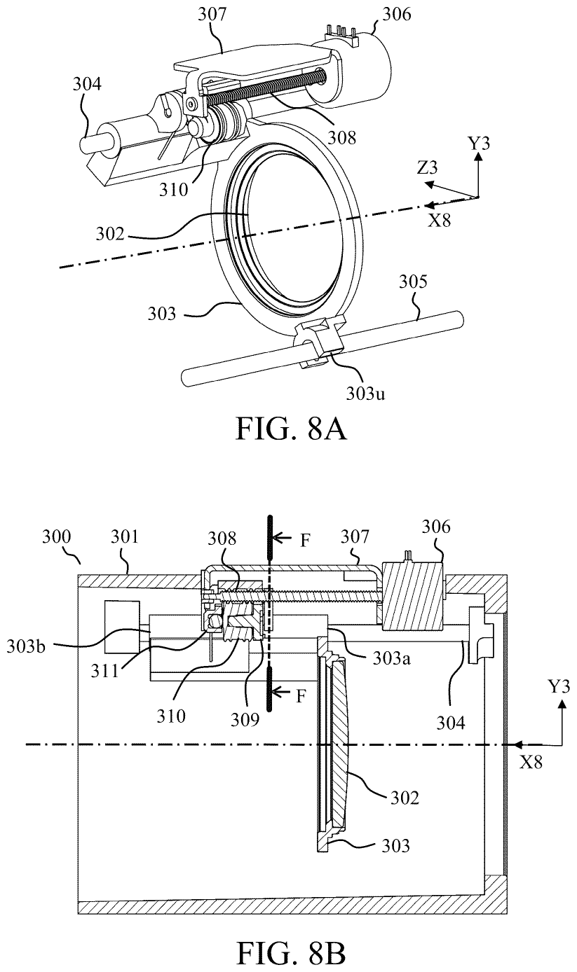

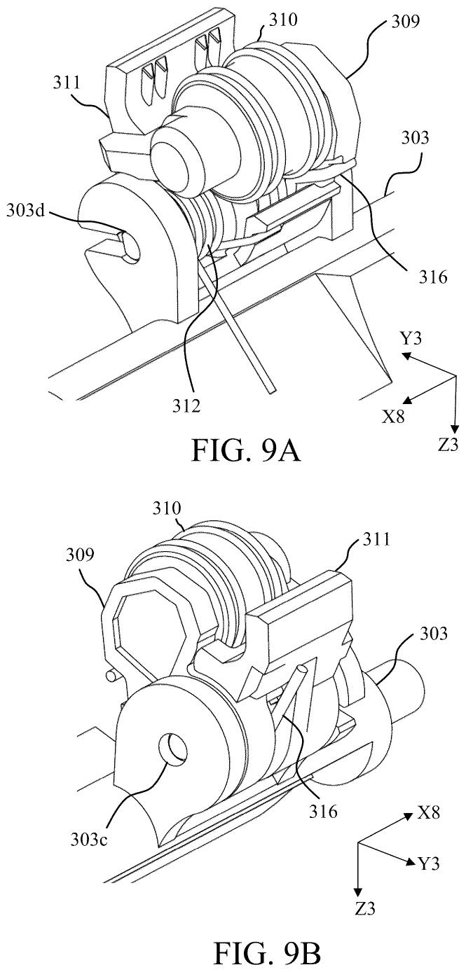

FIG. 8A is a perspective view illustrating a structure of an optical apparatus 300 from which a fixed lens barrel 301 is removed, and FIG. 8B is a cross-sectional view of the optical apparatus 300. FIGS. 9A and 9B are enlarged perspective views of a power transmission member 310 from which a leadscrew 308 is removed, viewed from different directions. In the present embodiment, a direction parallel to an optical axis of a lens 302 (optical axis direction) will be defined as an X8 direction, a direction orthogonal to the X8 direction and corresponding to a vertical direction of the optical apparatus 300 will be defined as a Y3 direction, and a direction orthogonal to both the X8 direction and the Y3 direction will be defined as a Z3 direction, as indicated by arrows in the drawings.

The optical apparatus 300 includes a lens holding frame 303 that holds the lens 302, and a cylindrical main guide bar 304 and a cylindrical sub guide bar 305, each having an axial direction parallel to the X8 direction and configured to linearly guide the lens holding frame 303 in the optical axis direction of the lens 302. The optical apparatus 300 further includes a sheet metal portion 307, a power source 306 fixed to the sheet metal portion 307, and a leadscrew 308 having a rotation axis direction parallel to the X8 direction and coupled to the power source 306. When electric power is supplied to the power source 306 from an unillustrated power supply or the like, the leadscrew 308 is rotationally driven. The optical apparatus 300 further includes a coupling member 309 coupled to the lens holding frame 303, a power transmission member 310 rotatably and slidably supported by the coupling member 309, a contact member 311 that contacts the power transmission member 310, and a compression torsion spring 312. The optical apparatus 300 further includes a ball 315 incorporated into the contact member 311, and a clamping torsion spring (third biasing unit) 316.

Next, detailed shapes of the coupling member 309, the contact member 311, the compression torsion spring 312, the ball 315, and the clamping torsion spring 316 will be described. Other components have the same shapes as those of the first embodiment, and thus a description thereof will be omitted.

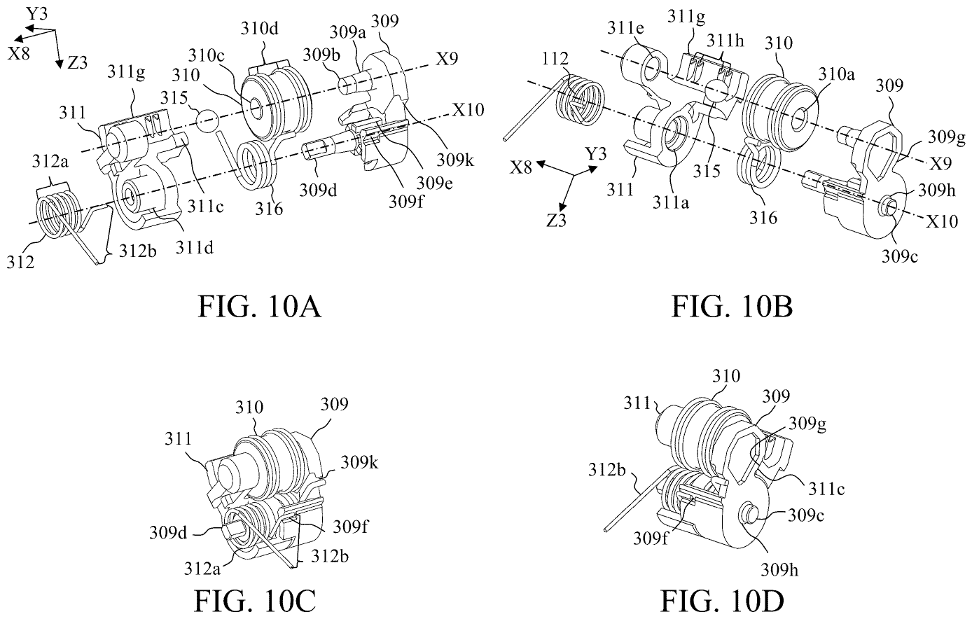

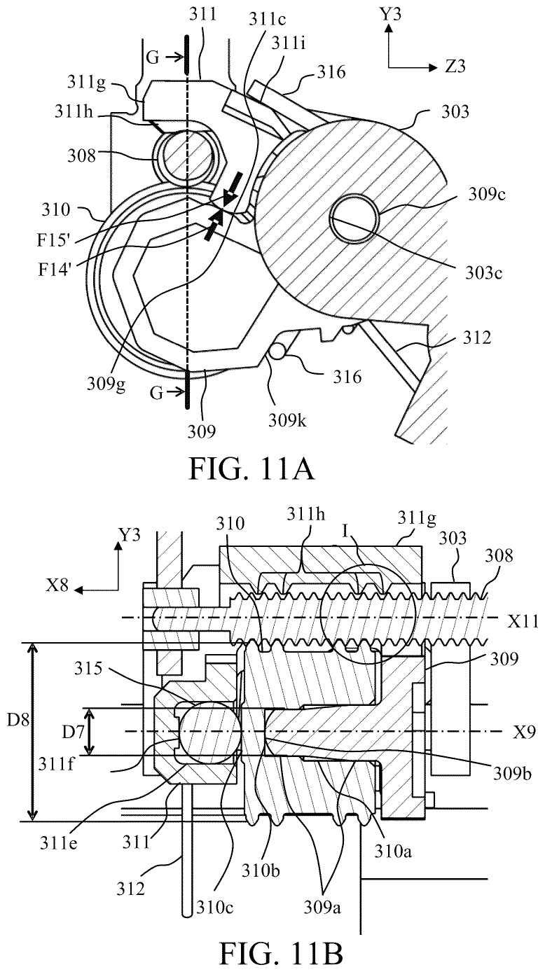

FIGS. 10A and 10B are exploded perspective views of components around the power transmission member 310, viewed from different directions. FIGS. 10C and 10D are perspective views illustrating assembled states corresponding to FIGS. 10A and 10B, respectively. FIGS. 11A and 11B are cross-sectional views taken along lines F-F and G-G in FIG. 8A, respectively.

In addition to structure similar to that of the first embodiment, the coupling member 309 includes an engagement shaft portion 309e into which the clamping torsion spring 316 and the contact member 311 are incorporated, and a rotation restricting portion 309g that restricts relative rotation relative to the contact member 311 about an X10 axis. The coupling member 309 further includes a clamping portion 309k to which a biasing force of the clamping torsion spring 316 is transmitted.

In addition to a shape similar to that of the first embodiment, the contact member 311 includes a rotation restricting portion (second contact portion) 311c that restricts relative rotation relative to the coupling member 309 about the X10 axis, and a clamping portion 311i to which the biasing force of the clamping torsion spring 316 is transmitted. The contact member 311 further includes a contact hole portion 311e in which the ball 315 is engaged and fixed, and a contact surface portion 311f that contacts the ball 315 in the X8 direction. The contact member 311 further includes an opposing portion 311g that faces the power transmission member 310 so as to sandwich the leadscrew 308 and is separated from the leadscrew 308 by a predetermined gap. The contact member 311 further includes an opposing tooth portion (third contact portion) 311h provided on the opposing portion 311g and configured to be engaged with a thread portion of the leadscrew 308.

The compression torsion spring 312 includes a compression spring portion (first biasing unit) 312a and a torsion spring portion (second biasing unit) 312b. The compression spring portion 312a biases the contact surface portion (first contact portion) 311f of the contact member 311 from the lens holding frame 303 toward the power transmission member 310 in the X8 direction. The torsion spring portion 312b biases both the lens holding frame 303 and the coupling member 309 in a direction orthogonal to the X8 direction, which is orthogonal to the optical axis, and biases the power transmission member 310 toward the leadscrew 308.

The clamping torsion spring 316 has a first end that biases the clamping portion 309k and a second end that biases the clamping portion 311i, and is incorporated into the engagement shaft portion 309e.

Next, biasing states among the components will be described. Biasing states of each component in a direction orthogonal to the X8 direction by the torsion spring portion 312b are the same as those of the first embodiment, and thus a description thereof will be omitted. Biasing states of each component in the X8 direction by the compression spring portion 312a differ in that the ball 315 is fixedly incorporated into the contact member 311 and contacts the power transmission member 310; however, other structures are the same as those of the first embodiment, and thus a description thereof will be omitted.

Since an engagement hole portion 311a is engaged with the engagement shaft portion 309e through the X10 axis, the contact member 311 can rotate relative to the coupling member 309 about the X10 axis. Further, the clamping torsion spring 316 biases the clamping portions 309k and 311i such that the rotation restricting portions 309g and 311c contact each other. At this time, forces with which the rotation restricting portions 309g and 311c contact each other are denoted as F14′ and F15′ and are illustrated in the drawings.

Thus, in a direction orthogonal to the X8 direction, the torsion spring portion 312b biases the power transmission member 310 toward the leadscrew 308, and the clamping torsion spring 316 biases the contact member 311 toward the power transmission member 310. At this time, as described above, the opposing portion 311g and the opposing tooth portion 311h are separated from the leadscrew 308 by a predetermined gap. The gap is configured to be smaller than an engagement depth, in a direction orthogonal to the X8 direction, at which a circumferential tooth portion (engagement portion) 310d is engaged with a thread portion of the leadscrew 308.

### (3-2) Tooth Skipping

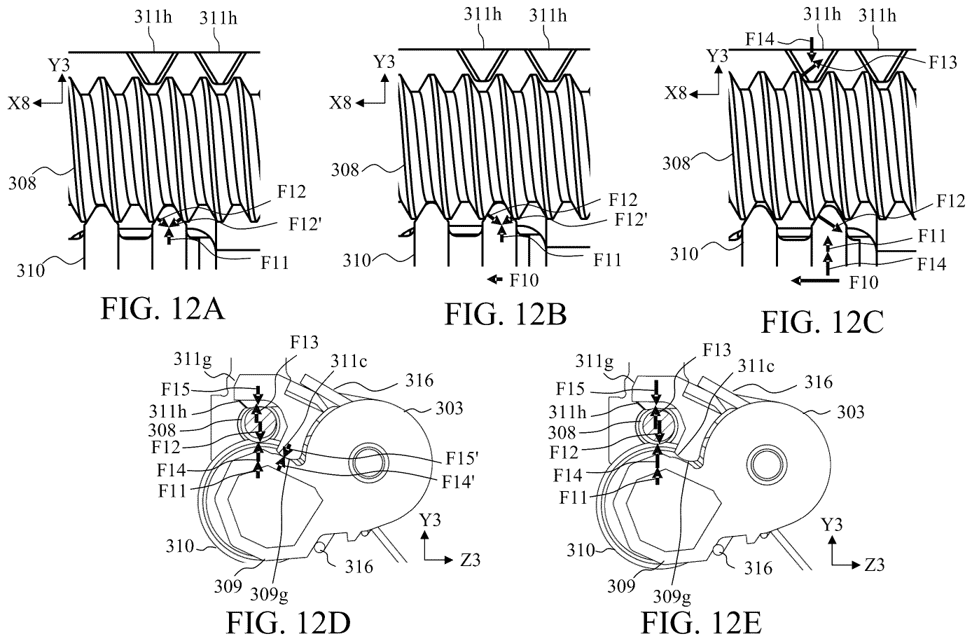

Tooth skipping in which the circumferential tooth portion 310d climbs over a thread portion of the leadscrew 308 will be described. First, with reference to FIGS. 12A to 12E, a biasing state of the power transmission member 310 in a case where an external force acts on the lens 302 in the X8 direction will be described. FIGS. 12A to 12C are enlarged views of region I in FIG. 11B. FIGS. 12A and 12B illustrate a state in which the power transmission member 310 does not separate from the leadscrew 308 in a direction orthogonal to the X8 direction. FIG. 12C illustrates a state in which the power transmission member 310 separates from the leadscrew 308 in a direction orthogonal to the X8 direction. FIG. 12D is a view of FIG. 12C viewed from a direction opposite to the X8 direction. FIG. 12E is an explanatory diagram of a biasing state just before tooth skipping when viewed from a direction opposite to the X8 direction. In a case where no external force acts on the lens 302, as illustrated in FIG. 12A, due to the torsion spring portion 312b, the power transmission member 310 receives a biasing force F11 and normal forces F12 and F12′ perpendicular to inclined surfaces defined by a lead angle of the thread portion of the leadscrew 308 from the coupling member 309. A resultant force of the biasing force F11 and the normal forces F12 and F12′ is balanced.

Next, a case where an external force F10 acts on the lens 302 will be described. When the external force F10 in the X8 direction acts on the lens 302, the external force F10 is transmitted to the lens holding frame 303, transmitted from the lens holding frame 303 to the coupling member 309 or the contact member 311, and transmitted from the coupling member 309 or the contact member 311 to the power transmission member 310. At this time, since the leadscrew 308 is fixed in the X8 direction, the power transmission member 310 receives the external force F10 and a reaction force against the external force F10 from one of the inclined surfaces defined by the lead angle of the thread portion of the leadscrew 308. More specifically, as illustrated in FIG. 12B, the normal force F12 perpendicular to the inclined surface of the lead angle increases as a reaction force against the external force F10. Since a resultant force of the normal forces F12 and F12′ in a direction orthogonal to the X8 direction balances with the biasing force F11, the normal force F12′ decreases. In a case where the resultant force of the normal forces F12 and F12′ in a direction orthogonal to the X8 direction is equal to or smaller than the biasing force F11, the power transmission member 310 remains biased toward the leadscrew 308, as illustrated in FIG. 12B. On the other hand, in a case where the resultant force of the normal forces F12 and F12′ in a direction orthogonal to the X8 direction is greater than the biasing force F11, the power transmission member 310 separates so as to climb up the inclined surface defined by the lead angle of the thread portion of the leadscrew 308. Thereafter, the power transmission member 310 reaches the state illustrated in FIG. 12C, and the normal force F12′ disappears. At this time, since the coupling member 309 that supports the power transmission member 310 rotates about the X10 axis and separates from the leadscrew 308, the contact member 311 biased against the coupling member 309 by the rotation restricting portion 311c also rotates together with the coupling member 309 about the X10 axis. When the coupling member 309 and the contact member 311 rotate about the X10 axis, the opposing tooth portion 311h comes into contact with the leadscrew 308. As described above, in the state illustrated in FIG. 12A, the gap between the leadscrew 308 and the opposing tooth portion 311h is smaller than the engagement depth (engagement height), in a direction orthogonal to the X8 direction, at which the circumferential tooth portion 310d is engaged with the thread portion of the leadscrew 308. Therefore, before the coupling member 309 rotates about the X10 axis and the circumferential tooth portion 310d completely climbs over the thread portion of the leadscrew 308, the opposing tooth portion 311h comes into contact with the leadscrew 308.

Thus, both the circumferential tooth portion 310d and the opposing tooth portion 311h contact the leadscrew 308, and the opposing tooth portion 311h receives a normal force F13 perpendicular to the inclined surface of a lead angle of the thread portion of the leadscrew 308. Hence, the power transmission member 310 and the contact member 311 receive normal forces F12 and F13, respectively, from the leadscrew 308. Therefore, a separating force that acts to separate both the power transmission member 310 and the contact member 311 from the leadscrew 308 in a direction orthogonal to the X8 direction is generated. On the other hand, when the opposing tooth portion 311h contacts the leadscrew 308, as illustrated in FIG. 11A, biasing forces F14′ and F15′ of the clamping torsion spring 316 decrease, and biasing forces F14 and F15 illustrated in FIGS. 12B and 12C increase. This occurs because the biasing force of the clamping torsion spring 316 acts not only as the biasing forces F14′ and F15′ that clamp the rotation restricting portions 309g and 311c, but also as the biasing forces F14 and F15 that clamp the leadscrew 308 by the circumferential tooth portion 310d and the opposing tooth portion 311h. In a case where, in a direction orthogonal to the X8 direction, the normal forces F12 and F13 are smaller than the biasing forces F14 and F15, the circumferential tooth portion 310d and the opposing tooth portion 311h do not further separate from the leadscrew 308. On the other hand, in a case where the normal forces F12 and F13 are larger than the biasing forces F14 and F15, the circumferential tooth portion 310d and the opposing tooth portion 311h further separate from the leadscrew 308. At this time, as illustrated in FIG. 12D, the entire biasing force of the clamping torsion spring 316 acts as the biasing forces F14 and F15 that clamp the leadscrew 308 by the circumferential tooth portion 310d and the opposing tooth portion 311h. Further, the rotation restricting portions 309g and 311c no longer contact each other, and the biasing forces F14′ and F15′ no longer act. In this case, the circumferential tooth portion 310d and the opposing tooth portion 311h gradually climb up the inclined surface defined by the lead angle of the thread portion of the leadscrew 308, and a tooth skipping phenomenon occurs in which the circumferential tooth portion 310d climbs over the thread portion eventually.

Thus, due to the magnitude of the external force F10, the leadscrew 308, the power transmission member 310, and the contact member 311 have three engagement states. A first engagement state (first state) is a state in which, in a direction orthogonal to the X8 direction, the external force F10 is not applied with a magnitude equal to or greater than a predetermined value, and a resultant force of the normal forces F12 and F12′ that increase or decrease due to the external force F10 is equal to or smaller than the biasing force F11. In this state, the circumferential tooth portion 310d is engaged with the thread portion of the leadscrew 308, and the opposing tooth portion 311h does not contact the leadscrew 308. A case where no external force F10 acts is also included in this state. A second engagement state (second state) and a third engagement state are states in which, in a direction orthogonal to the X8 direction, the external force F10 is applied with a magnitude equal to or greater than the predetermined value. More specifically, the second engagement state is a state in which, in a direction orthogonal to the X8 direction, the resultant force of the normal forces F12 and F12′ is greater than the biasing force F11, the opposing tooth portion 311h contacts the leadscrew 308, and the normal forces F12 and F13 are equal to or smaller than the biasing forces F14 and F15. In this state, the circumferential tooth portion 310d is engaged with the thread portion of the leadscrew 308, the opposing tooth portion 311h contacts the leadscrew 308, and tooth skipping is suppressed up to the biasing forces F14 and F15. The third engagement state is a state in which, in a direction orthogonal to the X8 direction, the resultant force of the normal forces F12 and F12′ is greater than the biasing force F11, the opposing tooth portion 311h contacts the leadscrew 308, and the normal forces F12 and F13 are greater than the biasing forces F14 and F15. In this state, the circumferential tooth portion 310d and the opposing tooth portion 311h gradually climb up the inclined surface of the lead angle of the thread portion of the leadscrew 308, and a tooth skipping phenomenon occurs in which the thread portion is climbed over.

Next, a proper magnitude relationship between the biasing force F11 and the biasing force F14 or F15 will be described. In a case where the leadscrew 308 is rotationally driven to move the lens 302 in the X8 direction, a smaller biasing force F11 reduces a driving load of the leadscrew 308, and thus the biasing force F11 may be set as small as possible. Further, in the above-described second engagement state, a larger biasing force F14 or F15 more strongly suppresses tooth skipping, and thus the biasing force F14 or F15 may be large. However, if the biasing force F14 or F15 is excessively large, tooth skipping does not occur even with respect to a large external force F10 or the like, such as when the optical apparatus 300 unintentionally falls, and the circumferential tooth portion 310d or the opposing tooth portion 311h may get damaged. Therefore, the spring may be designed such that the biasing force F14 or F15 falls within a range between an upper limit value assuming component damage and a lower limit value that prevents tooth skipping up to a proper external force F10. In a case where the biasing force F11 is greater than the biasing force F14 or F15, even if the engagement state transitions from the first engagement state to the second engagement state, a tooth skipping suppression effect by the biasing forces F14 and F15 cannot be obtained. Thus, although the biasing force F11 is increased in the first engagement state in order to increase the tooth skipping suppression effect, this conflicts with the reduction of the driving load. Accordingly, in order to suppress tooth skipping using the biasing forces F14 and F15 while the driving load is reduced by reducing the biasing force F11, the biasing force F11 may be set to be smaller than the biasing forces F14 and F15.

Next, a structure that enables the opposing tooth portion 311h to be separated from the leadscrew 308 by a predetermined gap with high accuracy in the first engagement state will be described. The ball 315 is incorporated into the contact member 311, and the ball 315 is a steel ball, a ceramic ball, or the like. Since such a ball has higher dimensional accuracy than a typical resin molded component, a tolerance of the ball 315 can be ignored. Since the power transmission member 310 and the ball 315 incorporated into the contact member 311 contact each other in the X8 direction, accumulation of tolerances between a tooth position of the circumferential tooth portion 310d and a position of the opposing tooth portion 311h is reduced. Moreover, since the contact member 311 is engaged with the coupling member 309 rotatably about the X10 axis, the contact member 311 can move only in a direction parallel to the X10 axis and is unlikely to tilt relative to the X10 axis. Therefore, the opposing tooth portion 311h can be separated from the thread portion of the leadscrew 308 by a predetermined gap with high accuracy in the X8 direction. Even when tolerance accumulation in a direction orthogonal to the X8 direction is considered, the opposing tooth portion 311h can be separated from the leadscrew 308 by the predetermined gap with high accuracy.

Next, the effects of incorporating the ball 315 into the contact member 311 will be described. By forming the ball 315 from a high-strength component such as metal or ceramic, wear caused by sliding rotation of the power transmission member 310 can be reduced, and a friction coefficient with the power transmission member 310 can be reduced.

Due to the above structure, a resistance force acting between the leadscrew 308 and the power transmission member 310 can be reduced based on a ratio between a diameter D8 and a diameter D7 illustrated in FIG. 11B, or the like. Thereby, loss that occurs when force is transmitted from the leadscrew 308 to the power transmission member 310 can be reduced. Thus, an output such as a driving force of the lens holding frame 303 can be increased relative to torque input transmitted from the power source 306 to the leadscrew 308, thereby providing an optical apparatus 300 with improved driving efficiency. Since rolling elements such as bearings can be omitted, the optical apparatus 300 having a reduced size and vibration and driving noises can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

Each embodiment can provide an optical apparatus that can reduce noise when moving a lens while improving the efficiency of an output, such as a driving force of a lens holding frame, in response to an input, such as torque from a power source.

What is claimed is:

1. An optical apparatus comprising:
a holding member movable in an optical axis direction;
a screw member extending in the optical axis direction and rotatable;
a transmission member configured to engage with the screw member and transmit power in the optical axis direction according to rotation of the screw member;
a coupling member configured to be coupled to the holding member and rotatably support the transmission member;
a contact member configured to contact the transmission member;
a first biasing unit configured to bias the contact member toward the transmission member in the optical axis direction; and
a second biasing unit configured to bias the transmission member toward the screw member,
wherein, in the optical axis direction, the transmission member is biased toward the coupling member by the contact member, and
wherein, in the optical axis direction, the coupling member is biased toward the holding member by the transmission member.

2. The optical apparatus according to claim 1, wherein the transmission member is sandwiched between the contact member and the coupling member in the optical axis direction.

3. The optical apparatus according to claim 1, wherein a rotational resistance torque acting on the support portion when the transmission member rotates is smaller than a rotational resistance torque acting on the engagement portion when the screw member rotates.

4. The optical apparatus according to claim 1, wherein the coupling member contacts a surface that includes a rotation axis of the transmission member in the optical axis direction.

5. The optical apparatus according to claim 1, wherein the contact member contacts a surface that includes a rotation axis of the transmission member in the optical axis direction.

6. The optical apparatus according to claim 1, wherein the support portion is one of a hole portion and a shaft portion.

7. The optical apparatus according to claim 1, wherein the following inequality is satisfied:
$$1 < D 2 / D 1 < 100$$
where D1 is a diameter of the support portion, and D is a diameter of the transmission member.

8. The optical apparatus according to claim 1, further comprising a third biasing unit that bias the contact member toward the coupling member in a direction orthogonal to the optical axis,
wherein the contact member is rotatably engaged with the coupling member,
wherein the contact member includes a first contact portion that contacts the transmission member, a second contact portion that restricts relative rotation relative to the coupling member in the direction orthogonal to the optical axis, and a third contact portion that faces the transmission member via the screw member in the direction orthogonal to the optical axis, and
wherein the third contact portion is separated from the screw member by a gap smaller than an engagement height of the engagement portion in the direction orthogonal to the optical axis.

9. The optical apparatus according to claim 8, wherein, in a first state in which a force equal to or greater than a predetermined value is not applied to the optical apparatus, the transmission member contacts the screw member, and
wherein, in a second state in which a force equal to or greater than the predetermined value is applied to the optical apparatus, the transmission member and the contact member contact the screw member.

10. The optical apparatus according to claim 9, wherein, in the second state, a force by which the transmission member and the contact member bias the screw member using the third biasing unit is larger than a biasing force by which the transmission member biases the screw member using the second biasing unit in the first state.

11. The optical apparatus according to claim 8, wherein the third contact portion includes a tooth portion engageable with a thread portion of the screw member.
